(19) United States
(12) Patent Application Publication
(10) Pub. No.: US 2024/0327998 A1
(43) Pub. Date: Oct. 3, 2024

(54) METHOD FOR GENERATING HYDROGEN BY DECOUPLED WATER ELECTROLYSIS

(71) Applicant: TotalEnergies OneTech, COURBEVOIE (FR)

(72) Inventor: David AYMÉ-PERROT, HUNINGUE (FR)

(73) Assignee: TotalEnergies OneTech, COURBEVOIE (FR)

(21) Appl. No.: 18/577,608

(22) PCT Filed: Jul. 7, 2022
(86) PCT No.: PCT/EP2022/068957

§ 371 Date: Jan. 8, 2024

(30) Foreign Application Priority Data
Jul. 7, 2021 (FR) FR2107350

(51) Int. Cl. C25B 1/50; C25B 1/04; C25B 5/00; H01M 8/065

(52) U.S. Cl. CPC C25B 1/50; C25B 1/04; C25B 5/00; H01M 8/065; H01M 2300/0011

(57) ABSTRACT

A method for generating hydrogen by water electrolysis, comprising only a positive electrode based on a bifunctional catalyst successively forming an oxygen evolution reaction (OER) electrode and a hydrogen evolution reaction (HER) electrode, depending if the device is subjected to or produces an electric charge, and a negative electrode using a redox pair M^{m+}/M, wherein M represents a metal element in reduced form and M^{m+} represents said metal element in oxidized form, submerged in an aqueous electrolyte, comprising performing biased electrolysis to cause, at the negative electrode, the metal element in oxidized form M^{m+} to be reduced to a reduced metal element M in solid form, the metal exhibiting an H₂ overvoltage, and to cause, at the positive electrode, O₂ to be generated to form the OER electrode and performing spontaneous reaction conversion between the positive electrode generating H₂, to form the HER electrode, and the negative electrode at which the M is oxidized into M^{m+}.

### CROSS REFERENCE TO RELATED APPLICATIONS

The present application is a U.S. National Phase Application under 35 U.S.C. § 371 of International Patent Application No. PCT/EP2022/068957 filed Jul. 7, 2022, which claims priority of French Patent Application No. 21 07350 filed Jul. 7, 2021. The entire contents of which are hereby incorporated by reference.

### FIELD OF THE INVENTION

The present invention relates to a method for generating hydrogen by water electrolysis.

### BACKGROUND

Conventional water electrolysis consists in decomposing the latter into hydrogen and oxygen (gas) under the influence of an applied electrical potential. Typically, two moles of hydrogen and one mole of oxygen are generated per mole of water consumed. Within the electrolyzer, hydrogen is produced at the cathode (negative electrode) whereas oxygen is generated simultaneously at the anode (positive electrode). Thus, there is the hydrogen evolution reaction (HER and the oxygen evolution reaction (OER).

There are 3 types of water electrolyzer technologies: 2 which are mature in liquid electrolyte, namely in acid or alkaline medium, and one in the gas phase at very high temperature (SOEC) which still needs to be optimized. Acid systems are called PEM (proton exchange membrane) electrolyzers. In particular, same are equipped with a proton conducting membrane (such as Nafion) which ensures both the ionic conductivity of the cell and the sealing of the gases between the 2 compartments, anode and cathode. The membrane remains a key, albeit expensive, element in such type of cell. In an alkaline medium, porous polymer films, called diaphragms (such as reinforced polyethersulfone, reinforced polyphenylene sulfide) act as a separator membrane. Same make possible the circulation of hydroxide ions from the electrolyte, which provides the ionic conductivity of the cell but are much less gas-tight than PEMs. The (less mature) high temperature technology is based on a ceramic conducting O²⁻ ions at high temperature (>500° C.) used as a separator/electrolyte membrane.

PEM type electrolyzers which operate in a concentrated proton medium make it possible to reach current densities on the order of 1 to 2 A/cm², much higher than the current densities displayed by alkaline electrolyzers. Furthermore, same also have much higher response dynamics. However, the stability of the materials is obviously subjected to a severe strain in acidic environments, which requires the use of noble materials/metals. Catalysts are expensive, platinum (Pt) is typically used at the cathode (HER) and iridium oxide (IrO2) at the anode (OER). Catalysts in an alkaline medium are generally nickel alloys which remain less expensive and have good stability.

The simultaneous generation of gases (oxygen and hydrogen) within the electrolyzers has certain limits. In particular, the rate of the hydrogen evolution reaction (HER) is necessarily dependent on the very slow kinetics of the oxygen evolution reaction (OER), which requires imposing a significant overvoltage on the electrochemical cell, and thus reduces the energy efficiency of the electrolysis. PEM systems serve for managing pressure differences between compartments, which is not possible with alkaline systems that need to be at isopressure within cathodic and anodic compartments.

The diffusion of gases through the membrane (“crossover gas”) remains problematic for optimal efficiency and is all the more significant during slow operation conditions. Such gas mixtures then require a post-purification of hydrogen.

Finally, in the case of an incident on the membrane, the high reactivity between O₂ and H₂ represents a real danger.

One approach to prevent such a scenario can be to carry out a decoupled water electrolysis, i.e. to produce a release of hydrogen and of oxygen shifted in time and/or space. In other words, hydrogen and oxygen are not produced simultaneously within the system, which definitely prevents a potential mixing of the gases. Therefore, such approach makes it possible to consider more secure and potentially less expensive system architectures.

Different decoupled water electrolysis systems are listed in the literature.

The use of redox mediators, in particular, was initiated by Cronin et al. (Nat. Chem. 2013, 5, 403-409) which decouples water electrolysis into 2 steps under biasing. First, the redox mediator (e.g. phosphomolybdic acid (H3O+)[H2PMo12O40]) is reduced at the cathode under biasing with release of oxygen at the anode. Then secondly, the reduced mediator is re-oxidized at the anode and the hydrogen produced is produced at the cathode. The same approach is found e.g. in (Wang et al., J. Mater. Chem. A, 2019, 7, 13149) where a polyaniline electrode is used as an intermediate redox pair.

Other approaches involve a specific Faradaic electrode in contact with a hydrogen generation electrode.

In WO201784589, Yonggang et al. (Fudan University) describe an alkaline electrolyzer with 3 electrodes, namely a catalytic electrode of the HER, an catalytic electrode of the OER and an Ni(OH)₂ intermediate electrode, which thus makes it possible to generate hydrogen by electrolysis of water in 2 successive biasing steps. The Ni(OH)₂ electrode certainly has a higher redox potential than same of oxidation of water, but the reaction kinetics of the latter is so slow that the oxidation of Ni(OH)₂ takes place preferentially. Firstly, the system composed of the HER and the Ni(OH)₂ electrode is charged: the water molecules are electrochemically reduced to hydrogen at the HER cathode whereas the nickel hydroxide electrode (Ni(OH)₂) is oxidized to nickel oxyhydroxide (NiOOH). Secondly, the system composed of the NiOOH electrode and the OER electrode is then polarized. The negative electrode of NiOOH is electrochemically reduced and returns to the initial Ni(OH)₂ state thereof whereas the hydroxide ions oxidize to oxygen at the positive electrode. Such system thus makes it possible to produce hydrogen and oxygen with a time-shift without requiring the use of any particular diaphragm. On the other hand, the system finally requires an overall charge potential following the 2 biasings higher than the potential of a conventional electrolysis. The regeneration of Ni(OH)₂ will require a significant overvoltage on the OER electrode.

In US2020/040467, Rothschild et al. claim an oxygen generation system involving two electrodes, one of the redox electrodes of which, in the oxidized state, may be reduced in the absence of electrical biasing, so as to generate oxygen. Typically, a positive Ni(OH)₂ electrode, which has good reversibility, is coupled to a negative water reduction electrode (HER) within an alkaline cell. Thus, during charge of the system, hydrogen is generated at the cathode while nickel hydroxide is oxidized to nickel oxyhydroxide (NiOOH) with good energy efficiency (due to the reversibility of the NiOOH/Ni(OH)₂ redox pair). Once said electrode is fully charged, the system must be stopped and the electrode must be regenerated. The application describes a thermal regeneration of the NiOOH electrode. By heating the cell to 95° C., the NiOOH electrode is reduced by water to Ni(OH)₂. The system can then be charged again and produce hydrogen. However, to be fully relevant in terms of being more energetically efficient, such approach requires the presence of a heat source that does not require the use of additional electrical power: which means an installation on a suitable zone, which can be limiting.

Another approach described in WO2019/193283 consists in implementing an electrochemical method for the production of gaseous hydrogen by electrolysis and then electrochemical conversion of H+ ions into gaseous hydrogen, either by debiasing along with production of electrical energy (battery), or catalytically. The method essentially consists in implementing, in a decoupled way, a step of electrolysis of an electrolyte producing gaseous oxygen and a step of electrochemical conversion of H+ ions into gaseous hydrogen in a chamber which contains a liquid phase and a gaseous phase which is not dissolved in the liquid phase. Such a method uses three electrodes.

### SUMMARY

More particularly, the goal of the invention is to solve the technical problem of providing a device and a method of decoupled water electrolysis.

More particularly, a goal of the invention is to solve the technical problem of providing a device and a method for producing hydrogen and oxygen.

The goal of the invention is to solve such technical problems with a good conversion efficiency for the production of hydrogen and/or oxygen, and preferentially providing a safe assembly.

Furthermore, a more particular goal of the present invention is to solve the technical problem consisting in simplifying and optimizing prior systems.

### BRIEF DESCRIPTION OF THE DRAWINGS

The examples are described with reference to the figures wherein:

FIG. 1 is a schematic representation of the system for the implementation of the method according to the invention, used during an electrolysis step.

FIG. 2 is a schematic representation of the device for the implementation of the method according to the invention, used during a conversion step.

### DETAILED DESCRIPTION

The invention consists in producing hydrogen (H₂, typically in gaseous form) under pressure via a method of decoupled electrolysis, i.e. a non-simultaneous production of hydrogen and oxygen, in order to enhance the safety of the system, along with a good conversion efficiency.

The invention relates to a method for generating hydrogen by water electrolysis, characterized in that same uses an electrochemical device 1 comprising only two electrodes 10, 20, namely a positive electrode 20 containing a bifunctional catalyst successively forming an oxygen evolution reaction (OER) electrode 20a and a hydrogen evolution reaction (HER) electrode 20b, according to whether the device 1 is subjected to an electric charge or delivers an electric charge, and a negative electrode 10 using a redox pair M^{m+}/M, wherein M represents a metal element in reduced form and M^{m+} represents said metal element in oxidized form, the electrodes 10, 20 being immersed in an aqueous electrolyte 50, the method comprising at least:
a step of performing electrolysis under biasing (charge) inducing, at the negative electrode 10, a reduction of the metal element in oxidized form M^{m+} into the reduced metal element M in solid form, the metal exhibiting an H₂ overvoltage, and inducing, at the positive electrode, the generation of oxygen O₂ at the positive electrode forming the OER electrode 20a;
a step of conversion by spontaneous reaction (during the bringing into contact of the electrodes via a discharge circuit 30) between the positive electrode 20 generating hydrogen H₂, forming the HER electrode, and the negative electrode 10 at which the metal element in reduced form M is oxidized into a metal element in oxidized form M^{m+}.

The invention further relates to a device 1 for implementing said method according to the invention:
at least one closed chamber intended to contain at least one aqueous electrolyte 50;
at least one positive electrode 20 apt to form the electrodes OER 20a and HER 20b intended to be immersed in the electrolyte 50;
at least one negative electrode 10 forming a redox electrode intended to be immersed in the electrolyte 50;
a power supply 35 connected to the positive electrode 20 and to the negative electrode 10.
an electric circuit 30, 40 for managing the charge (electrolysis step) and discharge (conversion step) of the device 1, apt to successively produce the functioning of the positive electrode as electrode OER 20a and as electrode HER 20b;
at least one discharge pipe for the gaseous oxygen generated by the method, and independently, at least one discharge pipe for the gaseous hydrogen generated by the method

In the invention, the term “HER electrode” is used when the positive electrode forms or functions as an HER electrode and the term “OER electrode” is used when the positive electrode forms or functions as an OER electrode. The second electrode (negative electrode) is also referred to as a “redox electrode”.

In the invention, the term “aqueous electrolyte” refers to an aqueous solution, thus containing protons H⁺ and/or hydroxide ions OH⁻, and optionally M^{m+} ions.

In the invention, the term “acid electrolyte” refers to an electrolyte having a pH<7 (+/−0.1).

In the invention, the term “basic electrolyte” refers to an electrolyte having a pH>7 (+/−0.1).

The invention uses a metal element M blocking the release of hydrogen when the oxidized form M^{m+} thereof is reduced. It is the phenomenon called hydrogen overvoltage, leading to an electrochemical state out of equilibrium that prevents the release of hydrogen during a biasing inducing the reduction of M^{m+}. Advantageously, the electrolysis step induces, concomitantly with the reduction of M^{m+} to M, a release of oxygen at the OER electrode.

Advantageously, the conversion step induces, concomitantly with the oxidation of M to M^{m+}, a release of hydrogen at the HER electrode.

According to one variant, the reduced metal element M in solid form forms a deposit on the negative electrode.

Typically, during the electrolysis step, a voltage or bias is applied between the redox electrode and the OER electrode.

According to one embodiment, the OER electrode is connected to the positive pole of a generator and the redox electrode is connected to the negative pole of the generator.

According to one variant, the conversion step by spontaneous reaction generates an electrical voltage, giving rise to an effective electrical energy.

Typically, during the conversion step a voltage is generated between the redox electrode and the HER electrode.

Advantageously, the voltage between the HER electrode and the redox electrode can supply an external electrical circuit and can advantageously be stored as electrical energy or a converted form of the generated electrical energy. As a result, the energy efficiency of the whole method is enhanced.

Thus, the invention provides a method of decoupled water electrolysis within a 2-electrode electrolyzer, one catalytic electrode of which functions successively as hydrogen evolution reaction (HER) and oxygen evolution reaction (OER) electrode associated with a second electrode forming a redox electrode (M^{m+}/M) with a hydrogen overvoltage and likely to reduce to a metal form.

According to one embodiment, the electrolysis step comprises a biasing (charge) step between the redox electrode in the oxidized state (negative electrode) and the OER electrode (positive electrode) immersed in the aqueous electrolyte. Thereby, advantageously, the negative electrode is reduced to metal whereas the positive electrode generates oxygen.

Typically, once the negative electrode is reduced and preferentially completely reduced to metal, the biasing is stopped.

Advantageously, the metal M resulting from the reduction of the redox electrode M^{m+} has a hydrogen overvoltage, which means that same can be deposited on a substrate, starting from M^{m+} ions while preventing gas release and that same is not reactive with regard to protons, for kinetic reasons.

The hydrogen overvoltage is ultimately of kinetic origin. The latter can be very slow on certain substrates. The overvoltage thereby corresponds to an additional potential necessary beyond the thermodynamic prerequisites for the reaction to occur at a given rate (Electrochemical methods, Fundamentals and Applications, Allen J. Bard, Larry R. Faulkner, John Wiley & sons, 2001).

According to the invention, the metal M is chosen so that same can be formed in solid form during charge (cathodic reduction) with the best possible efficiency. Preferentially, the absolute value of the overvoltage of the hydrogen release reaction on the metal M is greater than the difference E⁰(H⁺/H₂)−E⁰(M^{m+}/M) in acid medium and than the difference E⁰(H₂O/H₂)−E⁰(M^{m+}/M) in basic medium, where E⁰ is the standard redox potential.

According to the invention, such thermodynamically conceivable but kinetically blocked reaction between the metal and protons becomes possible by coupling the metal electrode with an electrode catalyzing the proton reduction reaction. The combination of the 2 electrodes is a fundamental aspect of the invention, since the spontaneous reaction, in other words the generation of both hydrogen and an electrical voltage, is thereby possible,

Advantageously, the decomposition of water, in two steps, serves first for the generation of oxygen during biasing and then for the spontaneous generation of hydrogen. Advantageously, the invention prevents the problem of gas diffusion from one compartment to another. Advantageously, the invention prevents the use of a gas-tight membrane. Advantageously, the device according to the invention is thereby less limited in terms of operation limit pressure than devices generating the gases simultaneously.

Advantageously, the device according to the invention comprises only two electrodes.

Advantageously, the device according to the invention comprises an electrical connection 30, 40 for managing (i) the charge, when the electrical circuit 30 electrically connects the electrodes 10, 20 to the generator 35, and (ii) the discharge of the device 1 when the electrical circuit 40 electrically connects the electrodes 10, 20 to the discharge device 45, the electrical connection 30, 40 being apt to produce the functioning the positive electrode 20 successively as the OER electrode 20a and as the HER electrode 20b.

Advantageously, the present invention serves to simplify and optimize the prior systems by using only two electrodes, the first electrode acting, successively, as an OER and an HER electrode.

First, a suitable biasing potential is applied via a voltage generator between the positive electrode OER and the negative redox electrode. Water is oxidized to oxygen at the positive electrode whereas the M^{m+} species are reduced to metal M at the second electrode forming a negative electrode.

Once the potential charge is stopped, the positive electrode (catalytic electrode) and the negative electrode (redox electrode in reduced state) are disconnected from the generator. Secondly, said electrodes are connected to an electric discharge circuit (such as a discharge resistor). The discharge circuit is conventionally referred to as an electrical discharge circuit. The electrodes are then the site of the spontaneous reaction between water and metal, leading to the generation of H₂ at the positive electrode (which becomes an HER electrode) and the oxidation of the metal M to cations M^{m+} at the negative electrode. Since the reaction is spontaneous, an electrical potential is also produced.

The steps of connection to the generator and disconnection from the generator are advantageously successive and cyclic.

According to a variant, the switching from the circuit connected to the generator to the circuit connected to one or a plurality of electronic components, such as e.g. one or a plurality of discharge devices or resistors, or equivalent devices forming e.g. a receiver dipole, is performed by a control module for the electrical circuits. Such switch can be made e.g. by means of one or a plurality of electrical switches. Advantageously, the electrical switches are controlled by one or a plurality of control modules positioning the electrical switch or switches depending on the electrolysis or conversion steps for an electrical operation in contact either with the generator(s) or with the discharge electronic component(s), such as a discharge resistor. The term “discharge resistor” is refers, very widely, to a device opposing a resistance to the electric current flowing in the discharge circuit, the term thus covers capacitors, and more generally any receiver dipole or multipole.

In addition to hydrogen generation, the operation of the system is similar to the operation of an accumulator (with limited efficiency). The electrolysis reaction under biasing corresponds to a charge while the spontaneous conversion reaction corresponds to the discharge of the system.

According to one embodiment, the conversion step is carried out when the negative electrode is in the reduced state, preferentially completely reduced, i.e. the available oxidized metal element M^{m+} was reduced to the metal element M. Said electrode is then connected to the positive electrode via an electric discharge circuit (also called external circuit), the latter then forming an HER electrode.

The system is then composed of the metal negative electrode (redox electrode) and a positive HER electrode. The conversion step uses a spontaneous reaction of oxidation of the metal by the aqueous medium, the HER electrode then generating hydrogen.

Advantageously, the system thereby supplies an electrical voltage U<ΔE=E⁰(H⁺/H₂)−E⁰(M^{m+}/M).

According to one embodiment, the redox pair is chosen from the redox pairs Pb²⁺/Pb, Zn²⁺/Zn, Sn²⁺/Sn, Mo³⁺/Mo, Ni²⁺/Ni, CO²⁺/Co.

Typically, the two electrodes (negative and positive) are immersed in an aqueous electrolyte.

According to one embodiment, the aqueous electrolyte has an acidic pH, which is then referred to as an acidic medium.

According to one embodiment, the aqueous electrolyte has a basic pH, which is then referred to as a basic medium.

According to one embodiment, the aqueous electrolyte comprises the metallic element M^{m+}. Thereby, according to one variant, M^{m+} in the electrolyte is in an ionic form, the counter-ion of which is preferentially chosen from the group comprising sulphates, oxides, nitrates, chlorides, citrates, phosphates, carbonates, fluorides, bromides, oxides, aqueous alkali metal or alkaline earth metal hydroxide solutions and mixtures thereof.

Advantageously, the aqueous electrolyte comprises sulfuric acid (H₂SO₄), or potassium hydroxide (KOH).

The basic electrolyte can also contain sodium hydroxide (NaOH).

The positive electrode forming the OER and/or HER electrode comprises or consists, at least on the surface, of one or a plurality of catalysts.

In acidic medium (aqueous electrolyte with acidic pH), the most effective catalyst for the HER electrodes is still platinum (Pt). Advantageously, platinum is a bifunctional catalyst.

In an alkaline medium, the bifunctional catalysts for the HER and OER electrodes are, e.g. bi-metal or tri-metal alloys, in particular containing Nickel, such as NiMo, Nico, NiFe, NiMoFe, NiMoCo, NiMoN, NiFeN. Compounds such as MoCo or MoO₂ can also be mentioned.

According to one embodiment, M represents Pb and M^{m+} represents PbSO₄ and the electrolyte is acidic (H₂SO₄).

According to one embodiment, M represents Zn and M^{m+} represents Zn²⁺ (potentially in the form of Zn(OH)₂ or Zn(OH₄]²⁻) and the electrolyte is a base.

Typically, the negative electrode functions as a redox electrode and comprises a substrate and at least one metal element M in reduced form and/or in oxidized form M^{m+}, depending on the progress of the charge/discharge cycle.

Advantageously, the substrate of the redox electrode has an overvoltage with respect to the release of hydrogen, thereby preferentially allowing metal deposition rather than the formation of H₂.

According to one variant, the substrate of the redox electrode is of the same nature as the deposited metal. The substrate can be selected from lead, zinc, tin, molybdenum, nickel, cobalt.

According to a variant, the substrate of the redox electrode is a metal stable with respect to the aqueous medium (aqueous electrolyte).

For example, in an acid medium, the substrate of the redox electrode is made of lead, copper, or cobalt.

For example, in a basic medium, the substrate of the redox electrode is made of zinc or nickel. Advantageously, for an optimal metal deposit M during charge, the species M^{m+} is preferentially present within the electrode so as to enhance the efficiency of the conversion process.

According to one embodiment, the redox electrode comprises the metal element on the surface and as substrate.

Advantageously, a PbSO₄ (insoluble in H₂SO₄ medium) redox electrode is used, which reduces to lead Pb on a substrate consisting of or comprising lead.

Such aspect can be independently patented, and the invention further covers a device and a method using a PbSO₄ (insoluble in H₂SO₄ medium) redox electrode which is reduced to lead Pb on a substrate consisting of or comprising lead.

Thereby, according to such independent aspect, the invention concerns:
a method for the generation of hydrogen by water electrolysis characterized in that the method uses a device comprising a hydrogen evolution reaction (HER) electrode, an oxygen evolution reaction (OER) electrode, said electrodes being apt to form a single electrode, and a redox electrode comprising the PbSO₄/Pb redox pair on a substrate consisting of or comprising lead, said electrodes being immersed in an aqueous electrolyte, said method comprising at least:
   a step of electrolysis by means of a supply of current inducing a reduction of the metal element in oxidized form M^{m+} to a reduced metal element M in solid form, the metal exhibiting an H₂ overvoltage, and inducing the generation of oxygen O₂ by the OER electrode;
   a step of conversion by spontaneous reaction at the HER electrode and generating hydrogen H₂, and the oxidation of the metal element in reduced form M into a metal element in oxidized form M^{m+} at the redox electrode.

The invention further relates to a device for implementing the above method comprising:
at least one closed chamber intended to contain at least one aqueous electrolyte;
at least one HER electrode and one OER electrode, where said electrodes can form one and the same electrode, intended to be immersed in the electrolyte;
at least one electrode forming a redox electrode comprising the PbSO₄/Pb redox pair n a substrate consisting of or comprising lead and intended to be immersed in the electrolyte;
a power supply connecting the redox electrode and the OER electrode;
an electrical circuit connecting the redox electrode and the HER electrode;
at least one discharge pipe for the gaseous oxygen generated by the method, and independently, at least one discharge pipe for the gaseous hydrogen generated by the method.

In relation to any aspect of the invention:

According to one embodiment, the species M^{m+} is in solution. Advantageously, the species M^{m+} in solution is present at a sufficient concentration not to be limited by the diffusional supply of matter. A supply of material by convection is then preferable.

Advantageously, the electrolysis and conversion steps are linked so as to produce successive “charge/discharge” cycles.

Advantageously, a phase of inerting the cell is carried out systematically between the electrolysis and the conversion steps. It means saturating the electrolyte with inert gas (typically N2) in order to expel the residual gas present in the electrolyte.

Typically, after the electrolysis reaction and oxygen formation, the residual oxygen present in the aqueous electrolyte is expelled by a saturation of the medium with the inert gas. After the conversion reaction and hydrogen formation, the residual hydrogen present in the aqueous electrolyte is expelled by a saturation of the medium with the inert gas.

Advantageously, the method of the invention serves to produce pressurized hydrogen gas electrochemically, in a decoupled way, so as to achieve high hydrogen gas pressures, e.g. >50 bars.

Advantageously, the gaseous hydrogen produced is collected, preferentially at a pressure higher than atmospheric pressure, and typically at least 10 bars. The gaseous hydrogen thereby collected is possibly stored outside the chamber in an H₂ storage tank.

According to one embodiment, the device according to the invention comprises a device for storing the gaseous hydrogen generated by the method, a device for storing the gaseous oxygen generated by the method and advantageously a device for storing the electrical energy generated by the method.

According to one embodiment, during the charge step, the DC power supply delivers a density of current i (A/m²) comprised between 100 and 5000, preferentially 200 and 3000, and even more preferentially 400 and 2000 A/m².

The aspects, variants, embodiments, features, preferred or advantageous, can be combined unless proven to be technically impossible.

Other goals, features and advantages of the invention will become clear to a person skilled in the art from reading the explanatory description which refers to examples which are given only as an illustration and which do not, in any way, limit the scope of the invention.

The examples form an integral part of the present invention and any feature which appears to be new with respect to any prior art on the basis of the description taken as a whole, including the examples, forms an integral part of the invention in the function and in the generality thereof.

Thereby, each example has a general scope.

On the other hand, in the examples, all the percentages are given by weight, unless otherwise indicated, and the temperature is expressed in degrees Celsius unless otherwise indicated, and the pressure is the atmospheric pressure, unless otherwise indicated.

### EXAMPLES

### Example 1: Device According to the Invention, Working in an Acid Electrolyte

Acid electrolyzers are the most efficient in terms of operating density of current and response dynamics.

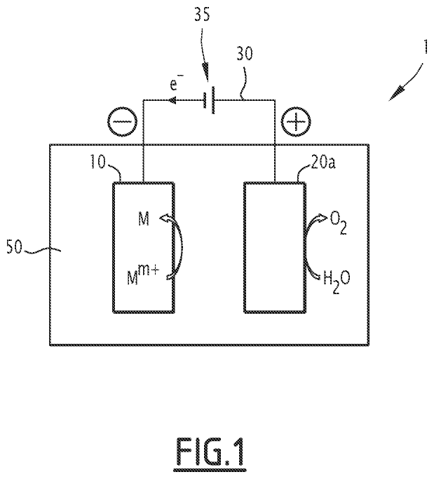

As illustrated in FIG. 1, the device and method according to the invention associates, within an electrochemical cell 1, a redox electrode 10 of Pb(substrate)/PbSO4 with a positive electrode 20 of platinum, in the presence of sulfuric acid as electrolyte 50. The single positive electrode 20 is denoted by 20a when same forms an OER electrode and by 20b when same forms an HER electrode.

The Pb/PbSO₄ redox electrode 10 is the negative electrode conventionally used in the operation of lead batteries in the presence of an H₂SO₄ 25% electrolyte, the redox behavior of which is governed by the equation:

$${H}_{2} O + Pb + {HSO}_{4}^{-} \begin{matrix}\text{?} \\ \text{?}\end{matrix} {PbSO}_{4} + {H}_{3}^{+} O + 2 {e}^{-}$$

$$\text{?} \text{indicates text missing or illegible when filed}$$

The redox potential of such electrode is −0.358 V vs ENH (hydrogen reference electrode).

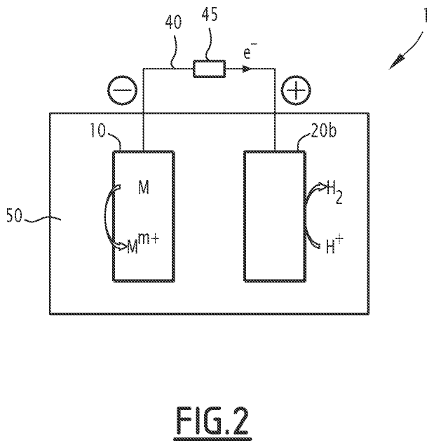

Advantageously, the first electrolysis step (oxygen generation; FIG. 1) is followed by a second step consisting of a spontaneous reaction generating hydrogen and electrical energy (FIG. 2).

The hydrogen release overvoltage is very high on Pb, which finally makes possible the reduction of PbSO₄ to Pb at the redox electrode 10 before the reduction of the H+ proton to H₂.

In terms of thermodynamics, the potential of the Pb/PbSO₄ redox pair being −0.358V, the lead should react (be oxidized) spontaneously with the proton, the latter reducing to hydrogen. Yet the extremely limited kinetics of said reaction is thereby akin to a significant overvoltage that ultimately annihilates the reaction.

A PbSO₄ electrode resulting from an initial step of oxidation of a lead electrode derived from the technology of lead accumulators is preferentially used.

For example, first:

The electrodes 10, 20a are connected to a generator 35 by means of a first electrical circuit 30. A voltage U>0.358+1.229=1.587V is applied between the PbSO₄ redox electrodes 10 and the OER electrode 20a.

The negative electrode PbSO₄ 10 (on Pb substrate) is reduced to Pb whereas the positive electrode 20a oxidizes water into oxygen, according to the following reactions:

$$\begin{matrix} & & {E}^{o} ( V vs ENH ) \\ \begin{matrix}{PbSO}_{4} + 2 e - \to & Pb + {SO}_{4}^{2 -}\end{matrix} & & - 0.358 V \\ 2 {H}_{2} O \to {O}_{2} + 4 H + + 4 e - & & 1.229 V\end{matrix}$$

the second electrolysis step is the hydrogen generation step, as shown in FIG. 1.

The high release overvoltage of H₂ on lead means that same remains stable in a protonated medium.

Secondly, the negative Pb electrodes 10 and the positive platinum electrodes 20a are disconnected from the generator 35 and connected to each other via an external resistive circuit 40 comprising a device forming a resistor 45 (e.g. a discharge resistor). The electrode 20a then acts as the HER electrode 20b.

The reaction of proton reduction by the lead, kinetically blocked on the surface of the lead, becomes possible again on the surface of the platinum electrode 20b. Lead is then oxidized to Pb²⁺ (PbSO₄) whereas hydrogen is released on the platinum, according to the following equations:

$${E}^{o} ( V vs ENH )$$

$$\begin{matrix}Pb + {SO}_{4}^{2 -} \to {PBSO}_{4} + 2 e - & - 0.359 V \\ 2 {H}^{+} + 2 e - \to {H}_{2} & 0. V\end{matrix}$$

the second step is the hydrogen generation step, as shown in FIG. 2.

The second system is thus the seat of a spontaneous reaction between the proton and lead species, at the 2 electrodes: it concerns a generator which then delivers an electrical voltage. Such voltage is less than or equal to the difference in the potentials of the 2 electrodes, i.e. U≤0−(−0.359)=0.359 V.

### Example 2: Device According to the Invention, Working in Alkaline (Basic) Electrolyte

Zinc-Air accumulators typically work in a basic medium (KOH 1M to 6M). Zinc deposition is more effective in a basic medium with respect to the release of hydrogen, and the stability of zinc is also much better than in an acid medium.

In the present example, the system 1 for decoupled electrolysis uses a catalytic electrode 20 containing a bifunctional tri-metal NiMoCo alloy, associated with a metal electrode 10 forming the redox electrode and is the seat of a zinc deposit during the charge and an oxidation of the zinc during the discharge. The electrolyte 50 is basic and contains a zinc salt, which is in the form of Zn(OH)₄²⁻ at the pH considered.

During the first phase of the decoupled electrolysis (FIG. 1), namely the charge of the electrochemical cell: a sufficient biasing (voltage ≥1.6V) is applied between the positive electrode 20 (OER electrode 20a) and the negative electrode 10 (metal cathode, i.e. the redox electrode) stable in an alkaline medium. The hydroxyl anions of the water are oxidized to oxygen on the positive electrode OER 20a and the zinc salt is reduced at the negative electrode 10 where a zinc deposit is formed, according to the following equations:

$$\begin{matrix} & & {E}^{o} ( V vs ENH ) \\ 4 {OH}^{-} \to {O}_{2} + 2 {H}_{2} O + 4 e - & & 0.401 V \\ {Zn ( OH )}_{4}^{2 -} + 2 e - \to Zn + 4 {OH}^{-} & & - 1.199 V\end{matrix}$$

During the first electrolysis step: oxygen is generated

During the second phase (FIG. 2), the electrodes are disconnected from the electrical circuit 30 comprising a generator 35 and connected therebetween via an electrical discharge circuit 40 comprising a device forming a resistor 45 (discharge resistor). The reaction between zinc and water is then spontaneous. In other words, zinc is oxidized and dissolves in the electrolyte 50 whereas hydrogen is formed at the positive electrode HER 20b, according to the following equations:

$$\begin{matrix} & & {E}^{o} ( V vs ENH ) \\ 2 {H}_{2} O + 2 e - \to {H}_{2} + 2 OH - & & - 0.828 V \\ Zn + 4 {OH}^{-} \to {Zn ( OH )}_{4}^{2 -} + 2 e - & & - 1.199 V\end{matrix}$$

Concomitantly with the release of hydrogen, the system generates an electrical voltage lower than (or equal to) the difference of the potentials of the redox pairs in the presence of U<|(−1.199)−(−0.828)|=0.371V.

During the second step: generation of hydrogen (and generation of an electrical voltage) takes place

1. A method for generating hydrogen by water electrolysis, wherein same uses an electrochemical device comprising only two electrodes, namely a positive electrode containing a bifunctional catalyst successively forming an oxygen evolution reaction electrode and a hydrogen evolution reaction electrode, according to whether the device is subjected to an electric charge or produces an electric charge, and a negative electrode using a redox pair M^{m+}/M, wherein M represents a metal element in reduced form and M^{m+} represents said metal element in oxidized form, the electrodes being immersed in an aqueous electrolyte, the method comprising-at-least:
a step of electrolysis under biasing inducing, at the negative electrode, a reduction of the metal element in oxidized form M^{m+} to a reduced metal element M in solid form, the metal exhibiting an H₂ overvoltage, and inducing, at the positive electrode, the generation of oxygen O₂ forming the OER electrode;
a step of conversion by spontaneous reaction, between the positive electrode generating hydrogen H₂, forming the HER electrode, and the negative electrode, seat of the oxidation of the metal element in reduced form M into a metal element in oxidized form M^{m+}.

2. The method according to claim 1, wherein the reduced metal element M in solid form forms a deposit on the negative electrode.

3. The method according to claim 1, wherein the step of conversion by spontaneous reaction generates an electrical voltage, giving rise to an effective electrical energy.

4. A method according to claim 1, wherein M represents Pb and M^{m+} represents PbSO₄ and the electrolyte comprises H₂SO₄.

5. The method according to claim 1, wherein M represents Zn and M^{m+} represents Zn²⁺ and the electrolyte is basic.

6. The device for implementing the method according to claim 1, wherein same comprises:
at least one closed chamber intended to contain at least one aqueous electrolyte;
at least one positive electrode capable of forming an OER electrode and an HER electrode intended to be immersed in the electrolyte;
at least one negative electrode forming a redox electrode intended to be immersed in the electrolyte;
a power supply connected to the positive electrode and to the negative electrode;
an electrical connection for managing the charge and discharge of the device, apt to successively produce the functioning the positive electrode as OER electrode and as HER electrode;
at least one discharge pipe for the gaseous oxygen generated by the method, and independently, at least one discharge pipe for the gaseous hydrogen generated by the method.

7. The device according to claim 6, wherein same comprises only two electrodes.

8. The device according to claim 6, wherein same comprises a device for storing the gaseous hydrogen generated by the method- and a device for storing the gaseous oxygen generated by the method.
